(19) United States
(12) Patent Application Publication
(10) Pub. No.: US 2012/0048452 A1
(43) Pub. Date: Mar. 1, 2012

(54) METHOD OF MANUFACTURING CERAMIC PASTE FOR MULTILAYER CERAMIC ELECTRONIC COMPONENT AND METHOD OF MANUFACTURING MULTILAYER CERAMIC ELECTRONIC COMPONENT HAVING THE SAME

(75) Inventors: Ju Myung SUH, Anyang (KR); Won Seop Choi, Suwon (KR); Jong Hoon Bae, Anyang (KR); Jun Hee Kim, Hwaseong (KR)

(73) Assignee: SAMSUNG ELECTRO-MECHANICS CO., LTD.

(21) Appl. No.: 13/191,053

(22) Filed: Jul. 26, 2011

(30) Foreign Application Priority Data
Aug. 31, 2010 (KR) 10-2010-0084850

(51) Int. Cl. C04B 35/64; B32B 37/02; C04B 35/622

(52) U.S. Cl. 156/89.12; 501/1

(57) ABSTRACT

There are provided a method of manufacturing a ceramic paste for multilayer ceramic electronic components and a method of manufacturing multilayer ceramic electronic components having the same. According to an exemplary embodiment of the present invention, there is provided a method of manufacturing a ceramic paste for multilayer ceramic electronic components, including: manufacturing a primary mixture in a slurry state by deagglomerating a primary mixture including a ceramic powder and a first solvent; forming the primary mixture into a wet cake state by volatilizing the first solvent; and forming a secondary mixture in a paste state by mixing and dispersing a second solvent having a higher viscosity than that of the first solvent in the primary mixture in the wet cake state.

### CROSS-REFERENCE TO RELATED APPLICATIONS

This application claims the priority of Korean Patent Application No. 10-2010-0084850 filed on Aug. 31, 2010, in the Korean Intellectual Property Office, the disclosure of which is incorporated herein by reference.

### BACKGROUND OF THE INVENTION

1. Field of the Invention

The present invention relates to a method of manufacturing a ceramic paste for multilayer ceramic electronic components having excellent dispersibility and a method of manufacturing multilayer ceramic electronic components having the same.

2. Description of the Related Art

Generally, electronic components using a ceramic material such as a capacitor, an inductor, a piezoelectric element, a varistor, a thermistor, or the like, include a ceramic element formed of a ceramic material, inner electrodes formed in the ceramic element, and outer electrodes mounted on surfaces of the ceramic element to be connected to respective inner electrodes.

Among ceramic electronic components, the multilayer ceramic capacitor is configured to include a plurality of stacked dielectric layers, the inner electrodes disposed to oppose each other, having the dielectric layer therebetween, and the outer electrodes electrically connected to the inner electrodes.

The multilayer ceramic capacitor has been widely used as a component of a mobile communications device such as a laptop computer, a PDA, a mobile phone, or the like, due to advantages such as miniaturization, high capacity, ease of mounting, or the like.

Recently, within the felectronic industry, electronic components have been miniaturized, have a high performance, and are relatively inexpensive as electronic devices have improved in performance and have been lightened and slimmed. In particular, as the speed of CPUs has increased, and high functional devices have been miniaturized, lightened and digitalized, research and development into a multilayer ceramic capacitor (hereinafter, referred to as an ‘MLCC’) to implement characteristics such as miniaturization, thinness, high capacity, low impedance in a high frequency area, or the like, has been actively progressed.

As the microminiaturization, ultra thinness, and ultra high-capacity of the MLCC have progressed, a highly stacked and high-capacity multilayer ceramic capacitor having a size of 0603 (0.6 mm×0.3 mm) and 1.01 μF or more has been released. Dielectric layers and inner electrodes used for the high stacking and high-capacity multilayer ceramic capacitor are a thin sheet having a thickness of about 1 μm or less. As the thin dielectric layers and the thin inner electrodes are highly stacked, deformations and defects may be increased during a stacking process and a compression process, such that it may be difficult to implement the ultra thin and ultra high-capacity multilayer ceramic capacitor.

Recently, in order to increase the stacking efficiency of the thin sheet, a thermal transfer stacking method used to transfer the sheet at high temperature and high pressure has been used. However, green chip defects have increased due to the increase of excessively thin electrodes. In order to solve the above problems, a phenomenon of extending the electrodes due to stacking and cutting processes is prevented by printing dielectric substances on margin parts of the dielectric layers on which the inner electrodes are not formed before the stacking process. The dielectric substances printed on the margin parts are manufactured in a paste form and are printed, such that a method of manufacturing paste according to the related art in which a fine ceramic powder is dispersed may be difficult to realize. Therefore, voids may remain on the dielectric layers after a firing process, thereby degrading the capacity and reliability of a final product.

### SUMMARY OF THE INVENTION

An aspect of the present invention provides a method of manufacturing a ceramic paste for multilayer ceramic electronic components having excellent dispersibility and a method of manufacturing multilayer ceramic electronic components having the same.

According to an exemplary embodiment of the present invention, there is provided a method of manufacturing a ceramic paste for multilayer ceramic electronic components, including: manufacturing a primary mixture in a slurry state by deagglomerating a primary mixture including a ceramic powder and a first solvent; forming the primary mixture into a wet cake state by volatilizing the first solvent; and forming a secondary mixture in a paste state by mixing and dispersing a second solvent having a higher viscosity than that of the first solvent in the primary mixture in the wet cake state.

The first solvent may be at least one selected from a group consisting of toluene, ethanol, and a mixture thereof.

An average grain size of the ceramic powder may be 0.8 μm or less.

A viscosity of the primary mixture in the slurry state may be 10 to 300 cps.

The second solvent may be a terpineol-based solvent.

A viscosity of the secondary mixture in the paste state may be 5,000 to 200,000 cps.

According to another exemplary embodiment of the present invention, there is provided a method of manufacturing multilayer ceramic electronic components, including: preparing a ceramic paste by manufacturing a primary mixture in a slurry state by deagglomerating a primary mixture including a ceramic powder and a first solvent, forming the primary mixture into a wet cake state by volatilizing the first solvent, and forming a secondary mixture in a paste state by mixing and dispersing a second solvent having a higher viscosity than that of the first solvent in the primary mixture in the wet cake state; forming first and second inner electrode patterns on a plurality of ceramic green sheets; forming a margin part dielectric layer on a margin part of the ceramic green sheet on which the first and second inner electrode patterns are not formed by using the ceramic paste; stacking the plurality of ceramic green sheets to form a ceramic laminate; forming a ceramic element by cutting and firing the ceramic laminate so that respective ends of the first and second inner electrode patterns are alternately exposed through end surfaces thereof; and forming first and second outer electrodes on the end of the ceramic element to be electrically connected to the ends of the first and second inner electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a multilayer ceramic capacitor according to an exemplary embodiment of the present invention;

FIG. 2 is a cross-sectional view showing the multilayer ceramic capacitor taken along line A-A′ of FIG. 1;

FIG. 3 is a cross-sectional view showing the multilayer ceramic capacitor taken along line B-B′ of FIG. 1;

FIG. 4 is a partially enlarged view of a portion of FIG. 2; and

FIGS. 5A, 5B, 6A and 6B are photographs of a cross section of an MLCC to which ceramic pastes according to an example and a comparative example are applied.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

The present invention relates to a method of manufacturing a ceramic paste for multilayer ceramic electronic components. The ceramic paste may absorb a step occurring due to the formation of inner electrodes in the multilayer ceramic electronic components and may be used to form margin part dielectric layers formed on margin parts of dielectric layers on which the inner electrodes are not formed in order to prevent diffusion in the inner electrodes.

As an example of the multilayer ceramic electronic components according to the exemplary embodiment of the present invention, there may be a capacitor, an inductor, a piezoelectric element, a varistor, or a thermistor. Herein, a multilayer ceramic capacitor (hereinafter, referred to as MLCC) as an example of the ceramic electronic components will be described below.

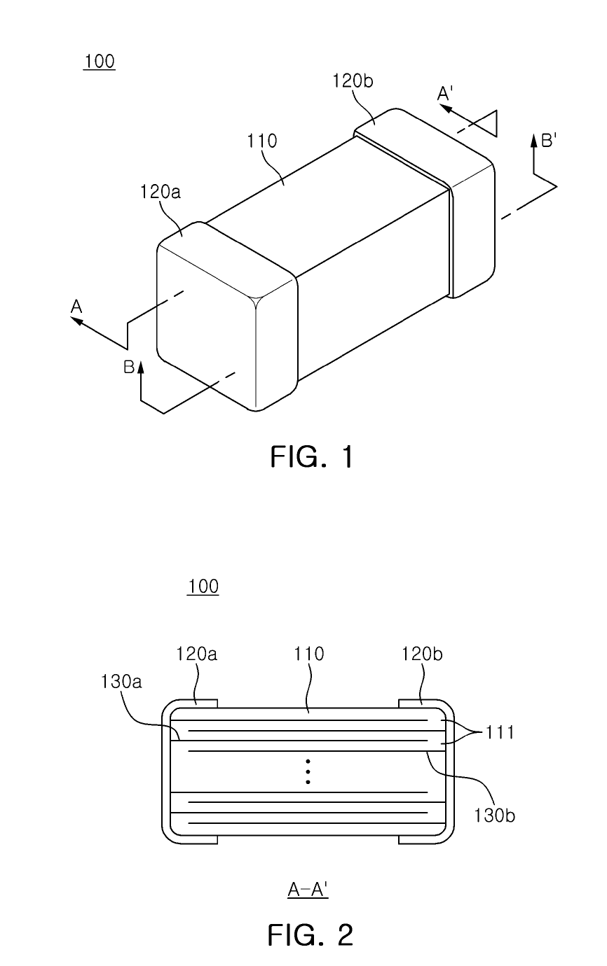

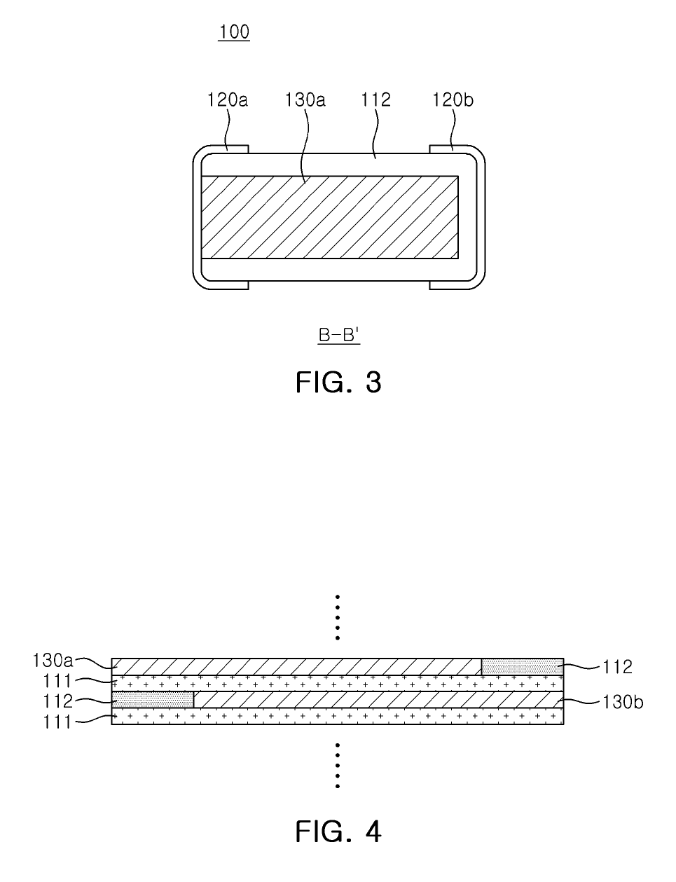

FIG. 1 is a schematic perspective view showing a multilayer ceramic capacitor 100 according to an exemplary embodiment of the present invention, FIG. 2 is a cross-sectional view showing the multilayer ceramic capacitor 100 taken along line A-A′ of FIG. 1, FIG. 3 is a cross-sectional view showing the multilayer ceramic capacitor 100 taken along line B-B′ of FIG. 1, and FIG. 4 is a partially enlarged view of a portion of FIG. 2.

Referring to FIGS. 1 to 4, the multilayer ceramic capacitor 100 according to the exemplary embodiment of the present invention may include a ceramic element 110 in which dielectric layers 111 and first and second inner electrodes 130a and 130b are alternately stacked. Respective ends of the ceramic element 110 may be provided with first and second outer electrodes 120a and 120b, each electrically connected to respective first and second inner electrodes 130a and 130b alternately disposed in the ceramic element 110.

The ceramic element 110 is not particularly limited in terms of a shape thereof, but may generally have a rectangular parallelepiped shape. Further, the ceramic element 110 is not particularly limited in terms of dimensions and may have, for example, a size of 0.6 mm×0.3 mm and may be a highly stacked and high-capacity multilayer ceramic capacitor of 1.0 μF or more.

The thickness of the dielectric layer 111 may optionally be changed to meet a design for the capacity of the multilayer ceramic capacitor, and, according to the exemplary embodiment of the present invention, the thickness of the dielectric layer may be 1.0 μm or less per layer after a firing process.

The first and second inner electrodes 130a and 130b may be stacked to be alternately exposed to the surfaces of ends of the ceramic element 110 opposed to each other. The first and second outer electrodes 120a and 120b may be formed at both ends of the ceramic element 110 and may be electrically connected to the alternately exposed ends of the first and second inner electrodes 130a and 130b, thereby configuring a capacitor circuit.

A conductive material included in the first and second inner electrodes 130a and 130b is not particularly limited, but non-metallic materials may be used therefor, since a material forming the dielectric layer is non-reducible.

An example of a non-metallic material used as the conductive material may include Ni or an Ni alloy. An example of the Ni alloy may be an alloy of at least one element selected from Mn, Cr, Co, and Al, and Ni, and a content of Ni in the alloy may be 95 wt % or more.

The thickness of the first and second inner electrodes 130a and 130b may be appropriately determined according to the usage or the like, for example, 0.1 to 1.0 μm.

A conductive material included in the first and second outer electrodes 120a and 120b is not particularly limited, but Ni, Cu, or an alloy thereof may be used. The thickness of the first and second outer electrodes 120a and 120b may be appropriately determined according to the usage or the like, for example, 10 to 50 μM.

The dielectric layer 111 configuring the ceramic element 110 is not particularly limited and may include a ceramic powder that is generally used in the art. Although not limited, the dielectric layer 111 may include, for example, a BaTiO3-based ceramic powder. For example, (Ba₁₋ₓCaₓ)TiO₃, Ba (Ti_{1-y}Ca_{y}) O₃, (Ba1-xCax) (Ti_{1-y}Zr_{y})O₃, or Ba(Ti_{1-y}Zr_{y})O₃, in which, for example, Ca, Zr and the like are partially dissolved in BaTiO₃, may be used. An average grain size of the BaTiO₃-based ceramic powder may be 0.8 μm or less, preferably, 0.05 to 0.5 μm, but is not limited thereto.

In addition, the dielectric layer may include, for example, a transition metal oxide or carbide, rare earth elements, Mg, Al, and the like, together with the ceramic powder.

According to the exemplary embodiment of the present invention, as shown in FIGS. 3 and 4, the dielectric layer 111 configuring the ceramic element may be provided with the inner electrodes 130a and 130b and the margin parts in which the inner electrodes are not formed are provided with the margin part dielectric layer 112. The margin part dielectric layer may absorb steps occurring due to the formation of the inner electrodes and may be formed to prevent diffusion in the inner electrodes.

According to the exemplary embodiment of the present invention, the dielectric layer for preventing diffusion in the inner electrodes is formed of the ceramic paste in which the fine ceramic powder is dispersed.

Hereinafter, the method of manufacturing ceramic paste will be described.

First, a primary mixture may be manufactured by mixing a first solvent with the ceramic powder. The primary mixture may further include a dispersant and other additives. As the ceramic powder, a powder equal to or similar to the ceramic powder included in the dielectric layer configuring the ceramic element may be used.

In addition, the average grain size of the ceramic powder may be 0.8 μm or less, preferably 0.05 to 0.5 μm.

As the first solvent, a material having relatively low viscosity may be used. For example, toluene, ethanol, or a mixture thereof may be used, but is not limited thereto.

Next, a primary mixture in a slurry state may be manufactured by deagglomerating the primary mixture. In the exemplary embodiment of the present invention, the deagglomeration may be performed using a bead mill and the conditions therefor may be a casting speed of 6 m/s, a flux of 50 hg/hr (using high shear micro mill), and a solid content of about 20 to 40 wt/%. After deagglomeration, dispersibility of the ceramic slurry may be configured by measuring the grain size of the ceramic powder, the specific surface area (BET), and the fine shape using an SEM.

The viscosity of the ceramic slurry may be 10 to 300 cps, preferably, 50 to 100 cps.

Next, the solvent of the primary mixture is substituted. In more detail, the secondary mixture may be manufactured by removing the first solvent and adding a second solvent.

The primary solvent may be volatized and removed by a distiller and thus, the primary mixture in a wet cake state may be manufactured. The second solvent may be introduced into the primary mixture in the wet cake state to manufacture the secondary mixture in the paste state.

The second solvent has a higher viscosity than the first solvent and may be generally used to manufacture the paste. Although not limited, for example, a terpineol-based solvent may be used, and, in more detail, dihdroterpinyl acetate (DHTA) may be used.

The terpineol-based solvent may have a good dispersion of the paste due to the high viscosity thereof, and in the leveling characteristics after the printing by reducing the drying speed due to a high boiling point.

The viscosity of the secondary mixture in the paste state may be 5,000 to 20,000 cps.

In addition, the secondary mixture may have additives such as a binder or the like together with the second solvent added thereto. The binder may serve to provide viscosity and thixotropy appropriate for, for example, screen printing, gravure printing and the like.

Therefore, any binder capable of implementing physical properties, such as thixotropy, adhesion, phase stability, and 3-roll milling may be used without limitation and an organic binder such as polyvinyl butyral resin may be used. In addition, the binder may further include ethyl cellulose resin used for the conductive paste for the inner electrodes.

In the related art, the ceramic powder may be dispersed in the high-viscosity state by being mixed with, for example, the solvent, the dispersant, and the like, by using the 3-roll mill.

Generally, in the case of the conductive paste for printing the inner electrodes, the conductive paste may be dispersed at high viscosity using the 3-roll mills to secure dispersibility; however, in the case of the ceramic powder, the ceramic powder has a high hardness, a small particle diameter, and a large specific surface area to have a strong agglomeration, such that it is difficult to uniformly disperse the ceramic power using the 3-roll mill.

In addition, in order to apply the ceramic powder to the microminiaturization and ultra thin multilayer ceramic capacitor having a size of 0603, ceramic powder having a smaller grain size should be used, and this case is difficult to secure dispersibility. When the dispersibility of the ceramic powder is not sufficiently secured, the voids remain on the dielectric layer after the sintering, thereby degrading capacity and reliability.

According to the exemplary embodiment of the present invention, the agglomeration of the ceramic powder may be minimized to secure dispersibility by being deagglomerated and dispersed at low viscosity meeting a requirment of the fine ceramic powder and then, the high-viscosity paste for printing may be manufactured. Therefore, a fine power having a grain size of 80 nm or less may be used.

In addition, the ceramic paste having dispersibility better than that of the related art may be manufactured, such that the surface roughness of the dielectric layer using the ceramic paste may be lowered and the drying film density may be improved.

Hereinafter, the method of manufacturing a multilayer ceramic capacitor according to the exemplary embodiment of the present invention will be described below.

First, a plurality of ceramic green sheets may be prepared. The ceramic green sheet may be manufactured by manufacturing a slurry by mixing the ceramic powder, the binder, and the solvent and manufacturing the slurry in a sheet having a thickness of several μm by a doctor blade method.

Next, first and second inner electrode patterns may be formed by applying the conductive paste for the inner electrodes to one surface of the ceramic green sheet. The first and second inner electrode patterns may be formed by the screen printing or the gravure printing method.

Next, the margin part dielectric layer may be formed on the margin part of the ceramic green sheet on which the first and second inner electrode patterns are not formed. The margin part dielectric layers may be formed of the ceramic paste according to the exemplary embodiment of the present invention.

The stacked ceramic green sheet and the inner electrode paste may be compressed with each other by stacking the plurality of ceramic green sheets on which the margin part dielectric layers are formed and compressing the plurality of ceramic greens sheets in the stacking direction. As a result, a ceramic laminate in which the ceramic green sheet and the inner electrode paste may be alternately stacked may be manufactured. In this case, according to the exemplary embodiment of the present invention, diffusion of the inner electrodes may be prevented by the margin part dielectric layer and the generation rate of steps due to the formation of the inner electrodes may be reduced.

Next, the ceramic laminate may be cut in the area corresponding to one capacitor to be formed in chip form. In this case, ends of the first and second inner electrode patterns may be cut to be alternately exposed through end surfaces thereof.

Thereafter, the laminate in chip form may be fired at, for example, about 1200□ to manufacture the ceramic element.

Next, the first and second outer electrodes that cover the end of the ceramic element may be formed to be electrically connected to respective first and second inner electrodes that are exposed to the end of the ceramic element. Thereafter, the surfaces of the outer electrodes may be subjected to a plating process using, for example, nickel, tin, or the like.

The dielectric layers may be formed by using the dispersed ceramic paste (comparative example) using the ceramic paste (example) manufactured according to the exemplary embodiment of the present invention and only the high-viscosity solvent and the measured surface roughness and drying film density are shown in the following Table 1.

TABLE 1

| | | Comparative |
|---|---|---|
| | Example | Example |
| Surface Roughness | 0.011 μm | 0.038 μm |
| (Ra) | | |
| Drying Film Density | 3.48 | 2.70 |
| (g/cm³) | | |

Referring to the above Table 1, according to the exemplary embodiment of the present invention, the surface roughness Ra of the dielectric layer may be reduced to ⅓. In addition, the drying film density may be increased from 2.7 g/cm³ to 3.48 g/cm³. That is, the agglomeration of particles may be reduced due to the increase in dispersibility, and in addition, the reduction of internal voids may be reduced.

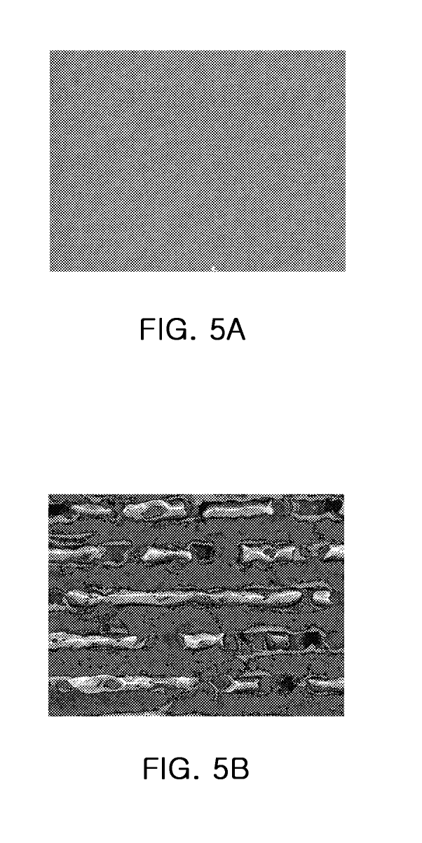

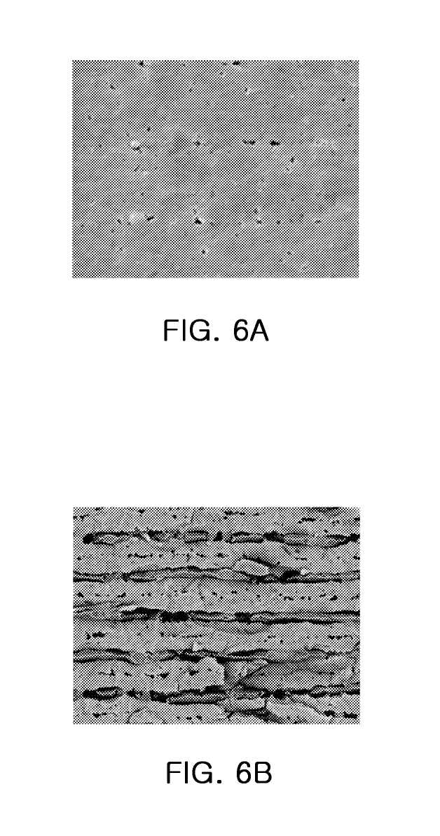

FIGS. 5A, 5B, 6A and 6B are photographs of a cross section of the 0603 sized MLCC to which the ceramic paste according to the example of the present invention and the comparative example is applied.

In more detail, FIG. 5A is an SEM photograph showing a fine structure of the dielectric layer to which the ceramic paste according to the example is applied and FIG. 5B is a photograph showing an cross section in an L direction of the MLCC. FIG. 6A is an SEM photograph showing the fine structure of the dielectric layer to which the ceramic paste according to the comparative example is applied and FIG. 6B is a photograph showing a cross section in the L direction of the MLCC.

Referring to FIGS. 5A, 5B, 6A and 6B, the comparative example has many internal voids after firing due to the degradation in the dispersibility of the ceramic paste, while the example has reduced voids by improving the dispersibility of the ceramic paste. The cutting yield was increased by printing the dielectric layer on the margin part with the ceramic paste manufactured according to the exemplary embodiment of the present invention in order to prevent the extension of the electrodes occurring during the stacking and compression processes, the porosity of the margin part dielectric layer was reduced due to the improvement of the dispersibility of the dielectric paste, the capacity was increased and the short rate was reduced due to the improvement of the thickness of the relative electrodes. Results not affecting other electrical characteristics were obtained.

In addition, the evaluated characteristics of the 0603 sized MLCC to which the ceramic paste according to the example and the comparative example was applied were disclosed in the following Table 2.

TABLE 2

| | | Comparative |
|---|---|---|
| | Example | Example |
| Cutting Yield | 92% | 11% |
| Porosity of Margin | 0.3 | 3.85 |
| Part Dielectric | | |
| Layer (%) | | |
| Capacity (μF) | 2.268 | 1.982 |
| DF (%) | 0.043 | 0.046 |
| IR (MΩ) | 29.2 | 15.5 |
| BDV (V) | 28 | 19 |
| Short (%) | 3 | 94 |

The capacity and the dielectric loss (DF) were measured at 1 kHz and 1Vrms by using a capacitance meter (Agilent 4284A).

The measurement of the insulation resistance used a high resistance meter (Agilent, 4339B) and the break down voltage (BDV) was measured using an HV BDV tester (PR12 PF).

The short was measured by counting the chips of which capacitance value was not measured by the electrical short.

In addition, the generation of cracks was measured by molding 100 chips and observing the cross section by an optical microscope and the accelerated lifespan was calculated by measuring the insulation resistance value in the state in which three times a rated voltage (6.3V) at a temperature of 150□ was applied for 72 hours.

Referring to the above Table 2, in the exemplary embodiment of the present invention, dispersibility was increased and porosity was remarkably reduced during firing. As a result, capacity was improved by about 15%. In addition, cracks were not generated and the characteristics of the break down voltage (BDV), the capacitance value, and the acceleration lifespan were improved as compared with the comparative example. In addition, the increase in dispersibility may be confirmed by the reduction in the short rate, such that the short rate was greatly improved as compared with the comparative example.

As set forth above, the method of manufacturing ceramic paste according to the exemplary embodiment of the present invention may improve dispersibility of the ceramic powder by using a method of using a solvent meeting the dispersion conditions of the ceramic powder and then substituting the solvents into other solvents. The dielectric layers using the ceramic paste manufactured according to the exemplary embodiment of the present invention may have excellent surface roughness, drying film density and low porosity.

When the ceramic paste manufactured according to the exemplary embodiment of the present invention is used for the MLCC, deformations in internal electrodes may be prevented, dielectric layers may be uniformly formed, and sintering characteristics may be improved. Therefore, the capacity of the capacitor may be improved and the values of the insulation resistance and the break down voltage may be improved. In addition, the short rate may be improved with the improvement of the dispersibility, thereby stably obtaining the electrical characteristics and increasing the manufacturing yield.

As a result, the exemplary embodiment of the present invention may contribute to the development of devices such as micro and ultra thin MLCCs, or the like.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a ceramic paste for multilayer ceramic electronic components, the method comprising:
manufacturing a primary mixture in a slurry state by deagglomerating a primary mixture including a ceramic powder and a first solvent;
forming the primary mixture into a wet cake state by volatilizing the first solvent; and
forming a secondary mixture in a paste state by mixing and dispersing a second solvent having a higher viscosity than that of the first solvent in the primary mixture in the wet cake state.

2. The method of claim 1, wherein the first solvent is at least one selected from a group consisting of toluene, ethanol, and a mixture thereof.

3. The method of claim 1, wherein an average grain size of the ceramic powder is 0.8 μM or less.

4. The method of claim 1, wherein a viscosity of the primary mixture in the slurry state is 10 to 300 cps.

5. The method of claim 1, wherein the second solvent is a terpineol-based solvent.

6. The method of claim 1, wherein a viscosity of the secondary mixture in the paste state is 5,000 to 200,000 cps.

7. A method of manufacturing multilayer ceramic electronic components, comprising:
preparing a ceramic paste by manufacturing a primary mixture in a slurry state by deagglomerating a primary mixture including a ceramic powder and a first solvent, forming the primary mixture into a wet cake state by volatilizing the first solvent, and forming a secondary mixture in a paste state by mixing and dispersing a second solvent having a higher viscosity than that of the first solvent in the primary mixture in the wet cake state;
forming first and second inner electrode patterns on a plurality of ceramic green sheets;
forming a margin part dielectric layer on a margin part of the ceramic green sheet on which the first and second inner electrode patterns are not formed by using the ceramic paste;
stacking the plurality of ceramic green sheets to form a ceramic laminate;
forming a ceramic element by cutting and firing the ceramic laminate so that respective ends of the first and second inner electrode patterns are alternately exposed through end surfaces thereof; and
forming first and second outer electrodes on ends of the ceramic element to be electrically connected to respective ends of the first and second inner electrodes.
